(19) United States
(12) Patent Application Publication
(10) Pub. No.: US 2008/0128075 A1
(43) Pub. Date: Jun. 5, 2008

(54) Method for fabricating 3D bevel sticky note pad

(76) Inventor: Wen-Chen Ho, Taipei City (TW)

Correspondence Address: BIRCH STEWART KOLASCH & BIRCH, PO BOX 747, FALLS CHURCH, VA, 22040-0747, US

(21) Appl. No.: 11/607,873

(22) Filed: Dec. 4, 2006

(51) Int. Cl. B32B 38/00; B31F 1/00

(52) U.S. Cl. 156/184; 156/221

(57) ABSTRACT

The present invention discloses a method for fabricating a 3D bevel sticky note pad comprising the following steps: preparing paper and dividing the paper into a plurality of blocks; printing identical figures on each block of the paper; applying a readherable sticky film to one edge of each block; conveying the paper and then positioning the front block of it; cutting off the front block and conveying the succeeding block to above the cut-off block and repeating the step to obtain a pad of sheet papers having identical figures; and beveling the pad of sheet papers to obtain a beveled face at the side opposite to the sticky films, wherein the figure revealed at the edge of one sheet paper is continuous to the figures revealed at the edges of the neighboring two sheet papers. Thereby, the 3D bevel sticky note pad has a superior visual effect.

### FIELD OF THE INVENTION

The present invention relates to a method for fabricating a sticky note pad, particularly to a method for fabricating a 3D bevel sticky note pad.

### BACKGROUND OF THE INVENTION

With the population of education and the development of commerce and industry, students or employees have widely used sticky notes or the likes to draft study notes or write down the miscellaneous incidents. The sticky note is commonly a square or rectangle of paper having a strip of low-tack adhesive on its edge, and the squares or rectangles of paper are stacked neatly and glued with the low-tack adhesive to form a pad.

Some sticky notes have undertone figures to achieve an aesthetic effect or have light-color words to obtain an advertising function without interfering with writing and reading.

However, the conventional sticky notes are so similar and only have tiny variations in the figures, shapes and dimensions thereof. Therefore, how to design a novel sticky note and make it outstand from multitudinous products of sticky notes is a common topic concerned by the manufacturers.

A R.O.C Patent Publication No.M249820 disclosed “Notes with a 3d Ornamental Advertisement”, wherein figures are presented on a beveled face. As to the fabrication process of the conventional note pad, sheet papers are firstly neatly stacked into a pad in a paper-neatening step. Next, one side of the pad is immersed into a glue, and the edges of the sheet papers are thus joined together. To fabricate a sticky note pad, a readherable sticky film is firstly applied onto one edge of each sheet paper. Thus, the stacked sheet papers are hard to be neatened. Therefore, the fabrication of the beveled face of a sticky note pad is more complicated, which is the reason why a sticky note pad having a 3D beveled face has not appeared yet.

### SUMMARY OF THE INVENTION

The primary objective of the present invention is to provide a method for fabricating a 3D bevel sticky note pad, wherein one side of a sticky note pad is cut into a beveled face, and the beveled face has figures, patterns or advertising words to present a size-enlargement impression, a gradient effect and a vivid stereo sensation; decreasing the sheets of the 3D bevel sticky note pad will not influence the integrality of the figures, patterns or advertising words. Thus, the method of the present invention can fabricate a useful, advertising and aesthetic 3D bevel sticky note pad.

To achieve the abovementioned objective, the method of the present invention comprises the following steps: preparing paper; printing identical figures on different blocks of the paper; applying a readherable sticky film onto one edge of each block; conveying the paper, positioning the front block of the paper and cutting off the front block; conveying the succeeding block to above the cut-off block, cutting off the succeeding block and repeating the step to obtain a pad of sheet papers; cutting one side of the sheet paper pad into a beveled face, wherein the beveled face is opposite to the sticky-film side; the revealed figure of each sheet paper is continuous to the revealed figures of the neighboring sheet papers on the beveled side of the sheet paper pad. Thereby, the method of the present invention can fabricate a 3D bevel sticky note pad having a superior visual effect.

### BRIEF DESCRIPTION OF THE DRAWINGS

FIG. 1 is a flowchart of the method according to a preferred embodiment of the present invention.

FIG. 2 to FIG. 9 are diagrams schematically showing the fabrication steps of the method according to a preferred embodiment of the present invention.

FIG. 10A and FIG. 10B are perspective views schematically showing the 3D bevel sticky note pad fabricated according to a preferred embodiment of the present invention.

FIG. 11 is a perspective view schematically showing the 3D bevel sticky note pad fabricated according to another preferred embodiment of the present invention.

### DETAILED DESCRIPTION OF THE PREFERRED EMBODIMENTS

The technical contents of the present invention are to be described in detail in cooperation with drawings below.

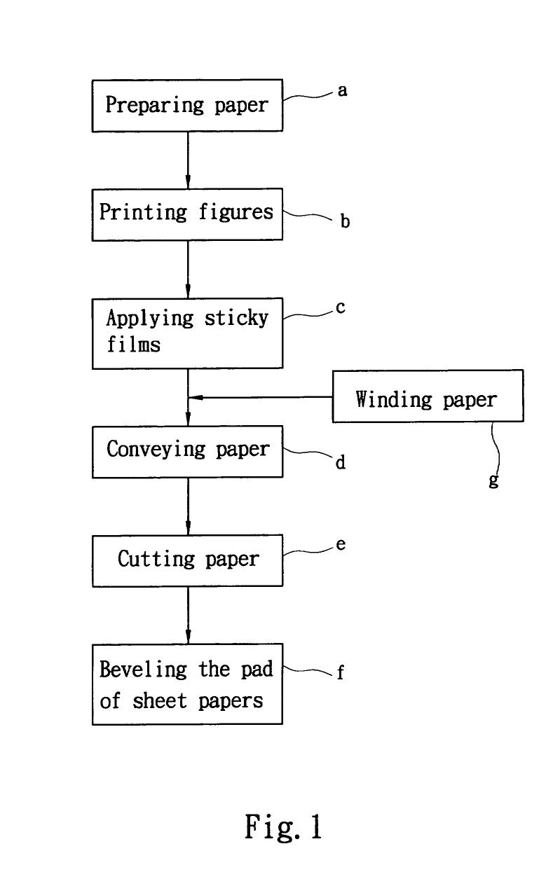

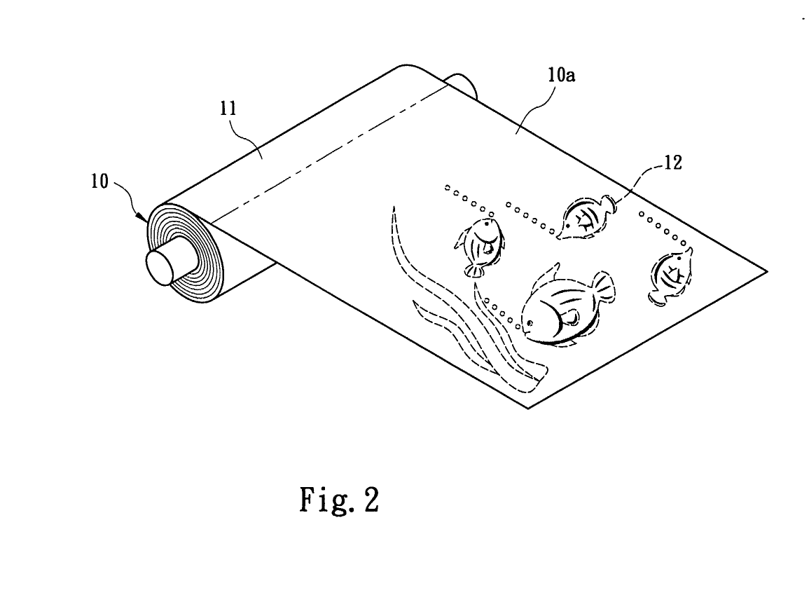

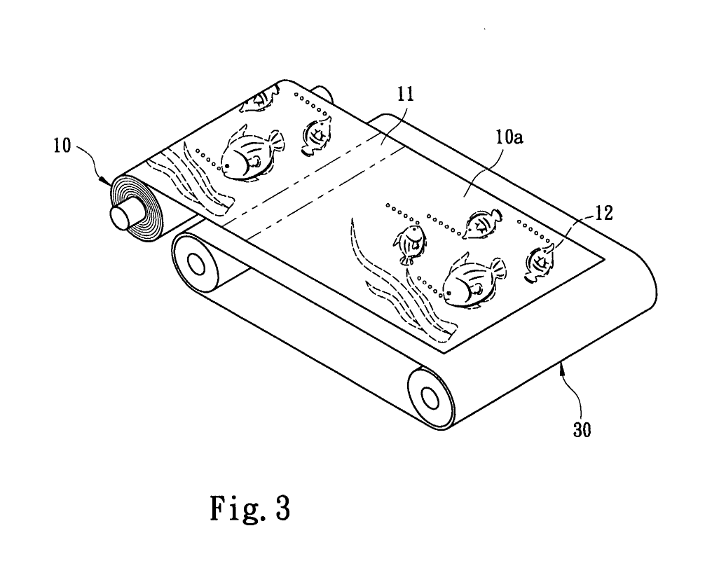

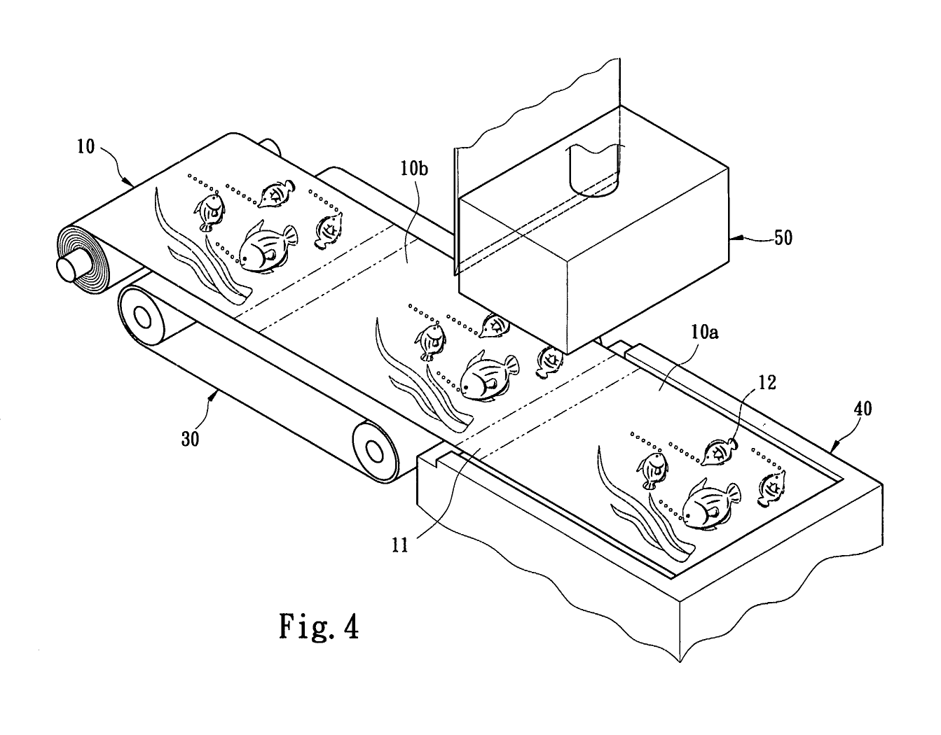

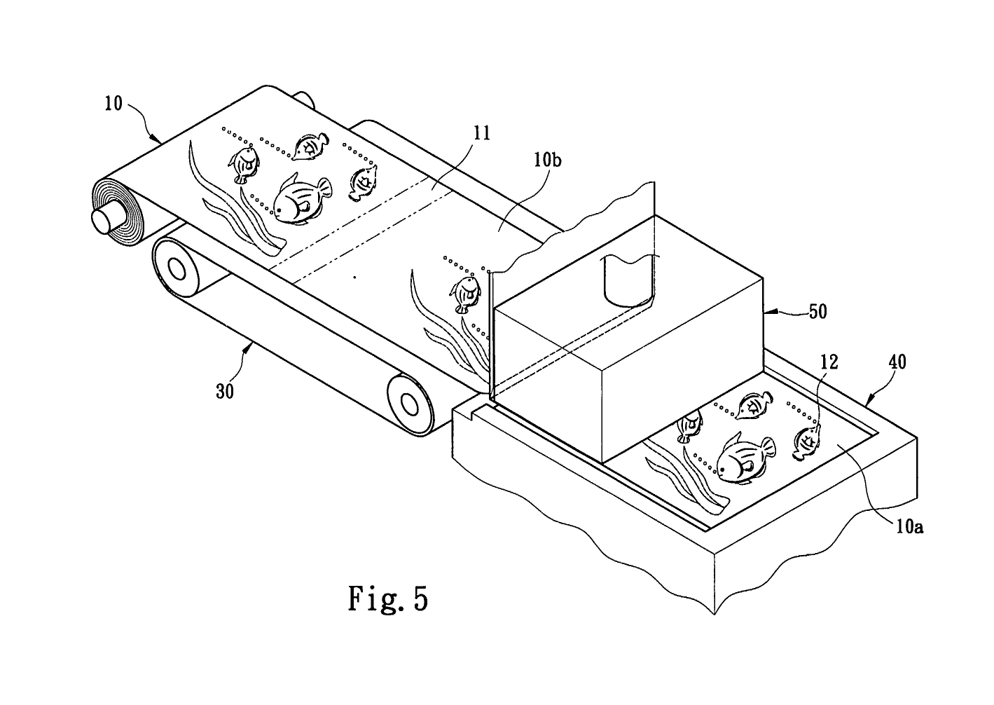

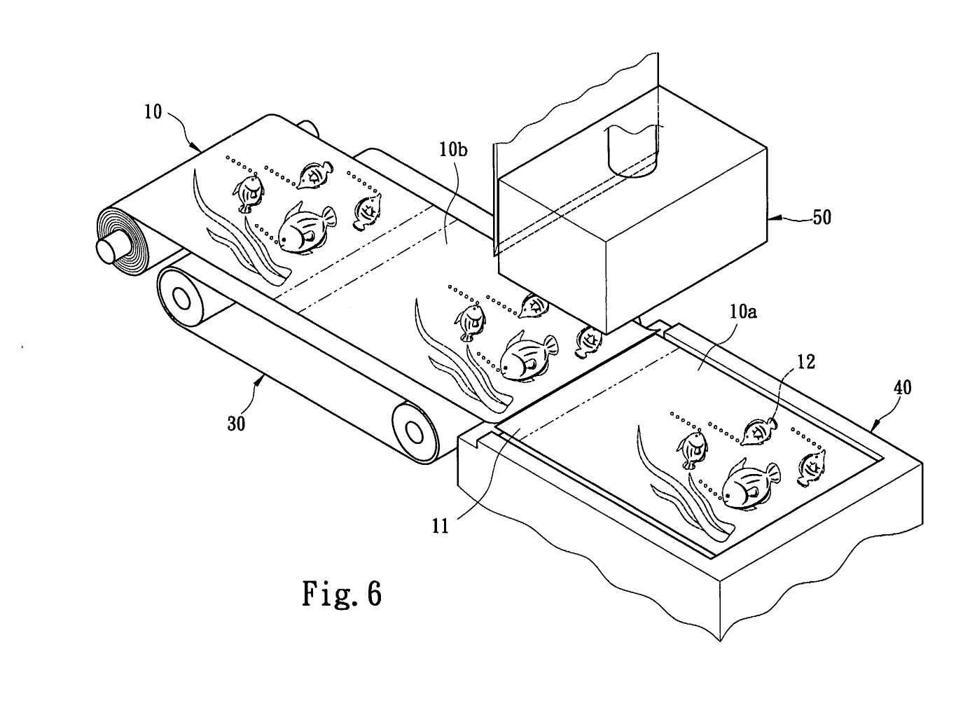

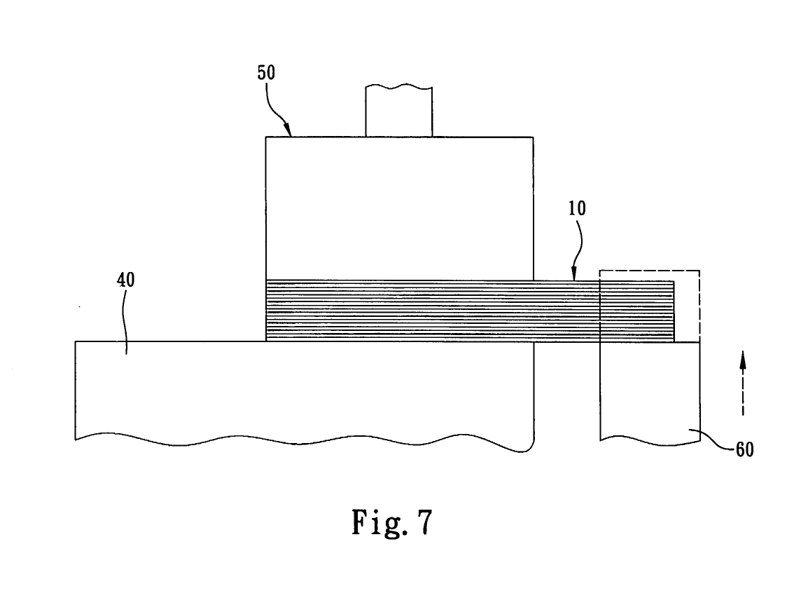

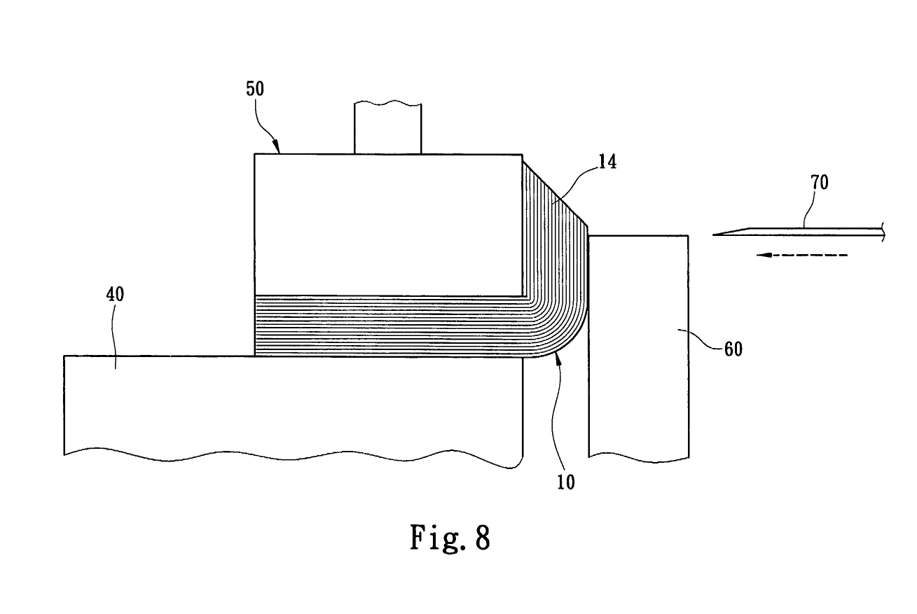

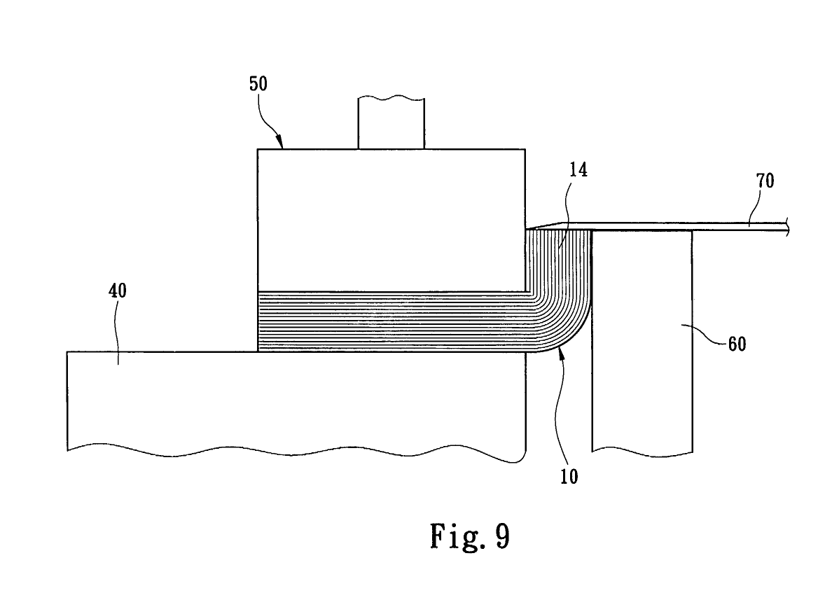

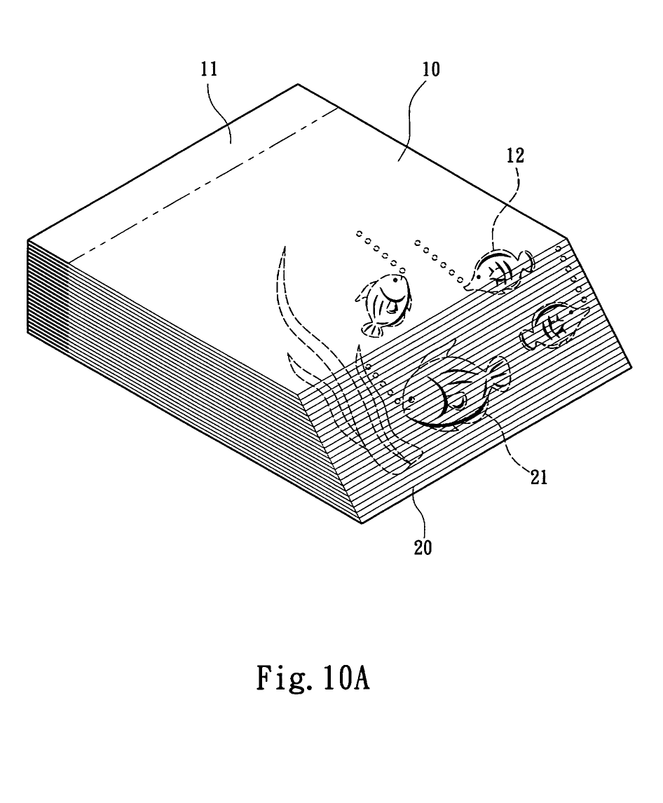

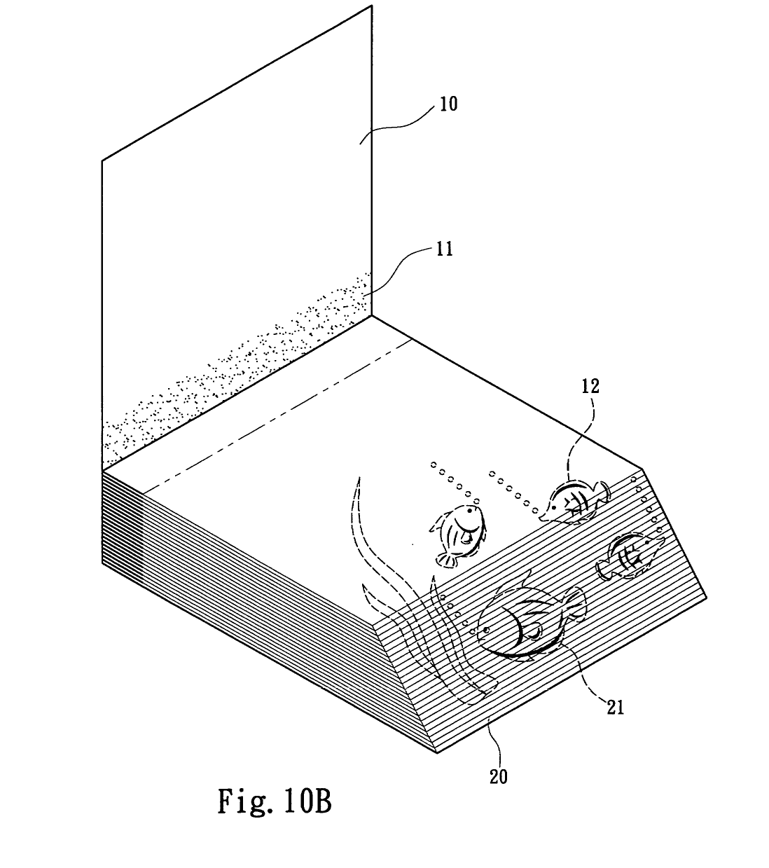

Refer to FIG. 1 a flowchart of the method according to a preferred embodiment of the present invention. According to the preferred embodiment, the method for fabricating a 3D bevel sticky note pad of the present invention comprises the following steps:
a. Preparing paper: the paper 10 is divided into a plurality of blocks 10a according to the dimensions of a sticky note;
b. Printing figures: identical FIGS. 12 are printed on each block 10a of the paper 10, and the FIG. 12 is not limited to but may be a pattern, a picture or a character (Refer to FIG. 2);
c. Applying sticky films: a readherable sticky film 11 is applied to one region of each block 10a, and the region is located on the back side of the FIGS. 12 and at the edge opposite to the FIGS. 12;
d. Conveying paper: the paper 10 is conveyed with a conveyer 30, and the front block 10a of the paper 10 is positioned with a positioning means (Refer to FIG. 4), wherein the front block 10a is transported to a positioning device 40; (A Step g of winding paper 10 may be performed before Step d, and the paper 10 is wound into a roll paper 10 to benefit conveying paper, as shown in FIG. 3)
e. Cutting paper: the front block 10a is cut off with a cutting device 50 (Refer to FIG. 5), and the succeeding block 10b is conveyed to above the cut-off block 10a (Refer to FIG. 6), and Step e is repeated to obtain a pad of sheet papers 10 having identical FIGS. 12;
f. Beveling the pad of sheet papers: the pad of sheet papers 10 obtained in the preceding step is beveled with a beveling means to obtain a beveled face 20 at the opposite side of the sticky films 11 (as shown in FIG. 10A), and the beveling means may be implemented with an oblique cutting method or a paper bending method, wherein in the paper bending method, a paper-pushing device 60 pushes the side to be cut to form a bent section 14 (Refer to FIG. 7 and FIG. 8), and the bent section 14 is cut off with a cutter 70 (Refer to FIG. 9) to obtain the beveled face 20.

Refer to FIG. FIG. 10A a perspective view schematically showing the 3D bevel sticky note pad fabricated according to a preferred embodiment of the present invention. As shown in FIG. FIG. 10A, the 3D bevel sticky note pad fabricated according to the method of the present invention comprises a plurality of sheet papers 10. A sticky film 11 is disposed between every two neighboring sheet papers 10. The sticky film 11 is sticky but removable. The user may write a note on one sheet paper 10 and peel off the sheet paper 10 to post it on an appropriate place. All the sheet papers 10 have identical figures at identical locations. The sheet papers 10 respectively have different lengths measured from the sticky films 11, and the lengths of the sheet papers 10 sequentially increase top down by a given increment (Refer to FIG. 10), and the face opposite to the sticky films 11 thus becomes a beveled face 20. Refer to FIG. 10A and FIG. 10B. The FIG. 21 revealed at the edge of one sheet paper 10 is continuous to the FIGS. 21 revealed at the edges of the neighboring two sheet papers 10. Thus, the FIG. 21 is integral on the beveled face 20, and the FIG. 12 on the topmost sheet paper 10 is also continuous to the FIG. 12 on the beveled face 20. The FIGS. 12 and 21 are not limited to but may be pictures, patterns or advertising words.

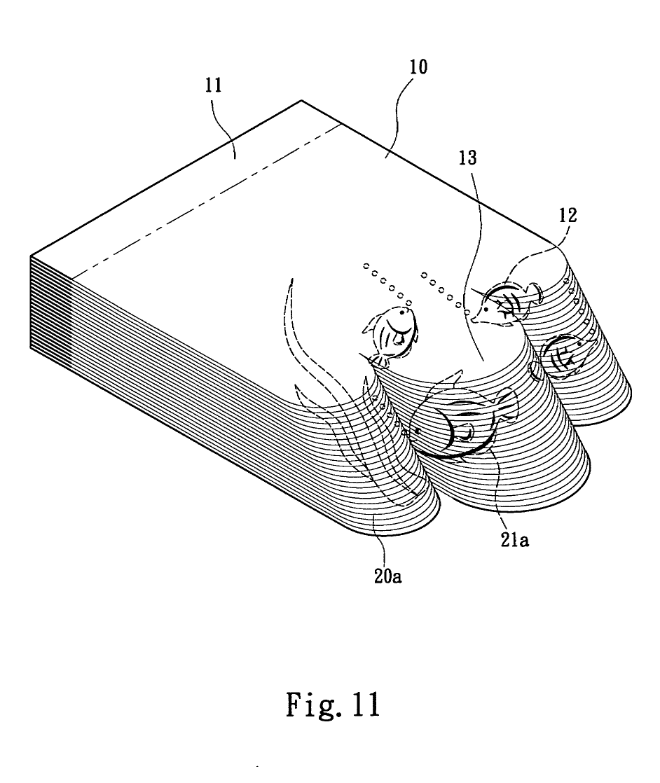

Refer to FIG. 11 a perspective view schematically showing the 3D bevel sticky note pad fabricated according to another preferred embodiment of the present invention. As shown in FIG. 11, the 3D bevel sticky note pad fabricated according to the method of the present invention comprises a plurality of sheet papers 10. However, the beveled face opposite to the sticky films 11 is not limited to the planar beveled face 20 but may also be a multiple-arc face 20a having a plurality of arc portions 13. The technical means of forming the FIGS. 2 la on the beveled face 2a is similar to that of the preceding embodiment and will not be repeated here.

The present invention proposes a method for fabricating a 3D bevel sticky note pad, wherein one side of a pad of sheet papers 10 is cut into a beveled face 20, and the beveled face 20 has pictures, patterns or advertising words to present a size-enlargement impression, a gradient effect and a vivid stereo sensation; decreasing the sheets of the 3D bevel sticky note pad will not influence the integrality of the figures. Thus, the method of the present invention can fabricate a useful, advertising and aesthetic sticky note pad. In comparison with the conventional sticky note pad, the 3D bevel sticky note pad fabricated according to the method of the present invention has a superior visual effect and can provide an advertising function and an aesthetic experience.

Those described above are the preferred embodiments to exemplify the present invention. However, it is not intended to limit the scope of the present invention. Any equivalent modification and variation according to the spirit of the present invention is to be also included within the scope the present invention.

What is claimed is:

1. A method for fabricating a 3D bevel sticky note pad, comprising the following steps:
preparing paper, wherein paper is divided into a plurality of blocks according to the dimensions of a sticky note;
printing figures, wherein identical figures are printed on each said block of said paper;
applying sticky films, wherein a readherable sticky film is applied to one edge of each said block;
conveying paper wherein said paper is conveyed, and then said the front block of said paper is positioned with a positioning means;
cutting paper, wherein the front said block is cut off, and the succeeding said block is conveyed to above the cut-off said block, and the step is repeated to obtain a pad of sheet papers having identical figures; and
beveling the pad of sheet papers, wherein said pad of sheet papers obtained in the preceding step is beveled with a beveling means to obtain a beveled face at the side opposite to said sticky films,
wherein the figure revealed at the edge of one said sheet paper is continuous to the figures revealed at the edges of the neighboring two said sheet papers, and the figure is thus integral on said beveled face.

2. The method for fabricating the 3D bevel sticky note pad according to claim 1, wherein said figure is a pattern or a picture.

3. The method for fabricating the 3D bevel sticky note pad according to claim 1, wherein said figure is a character.

4. The method for fabricating the 3D bevel sticky note pad according to claim 1, wherein said sticky film is located on the back side of said figures and at the edge opposite to said figures.

5. The method for fabricating the 3D bevel sticky note pad according to claim 1, further comprising a paper-winding step, wherein said paper having printed figures is wound into a roll paper to benefit conveying said paper.

6. The method for fabricating the 3D bevel sticky note pad according to claim 1, wherein said positioning means is to transport the front said block of said paper to a positioning device and then position the front said block of said paper with said positioning device.

7. The method for fabricating the 3D bevel sticky note pad according to claim 1, wherein said beveling means is to bevel one side of said pad of sheet papers into said beveled face with an oblique cutting method.

8. The method for fabricating the 3D bevel sticky note pad according to claim 1, wherein said beveling means is to bevel one side of said pad of sheet papers into said beveled face with a paper bending method.

9. The method for fabricating the 3D bevel sticky note pad according to claim 1, wherein said beveled face makes said sheet papers have sequentially-increased lengths measured from said sticky films.

10. The method for fabricating the 3D bevel sticky note pad according to claim 9, wherein said lengths of said sheet papers are sequentially increased by a given increment.
